(19) United States
(12) Patent Application Publication
(10) Pub. No.: US 2004/0134733 A1
(43) Pub. Date: Jul. 15, 2004

(54) Vibration absorber

(76) Inventor: James Gary Wood, Albany, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/341,024

(22) Filed: Jan. 13, 2003

(51) Int. Cl. F16F 7/10

(52) U.S. Cl. 188/379

(57) ABSTRACT

A vibration-reducing apparatus mounted to a machine that vibrates during operation. The apparatus includes a spring and mass combination tuned to a natural frequency of oscillation substantially equal to the fundamental frequency of the machine's vibration at operating speed. The apparatus also includes at least one additional mass and spring combination tuned to a natural frequency of oscillation substantially equal to another harmonic, such as the second harmonic, frequency of the machine's vibration at operating speed. Thus, the apparatus absorbs the machine's vibration, resulting in a quieter, smoother machine.

### (e) BACKGROUND OF THE INVENTION

1. Field of the Invention

This invention relates generally to a vibration-reducing apparatus for a vibrating body, and more particularly a vibration-reducing apparatus that includes a plurality of spring and mass combinations tuned to the frequency of a vibrating machine.

2. Description of the Related Art

Many different kinds of machines operate by reciprocating an object back and forth along a path. The rapid stopping and starting of a reciprocating body causes vibrations in surrounding structures as the body stops and reverses direction of travel. For example, free piston Stirling cycle engines have a working gas that is moved between a warmer space and a cooler space by a reciprocating displacer to drive a reciprocating piston. The housing containing the working gas, piston and displacer can vibrate substantially during operation as the engine converts thermal energy to mechanical energy.

It is desirable to reduce the vibrations caused by machines, such as free piston Stirling cycle engines. A vibration absorber apparatus for accomplishing this purpose is described in U.S. Pat. No. 5,895,033 to Ross et al., which is incorporated herein by reference. Ross et al. describe an apparatus that is mounted to the housing of a free piston Stirling cycle machine. The apparatus includes a spring and an attached mass. The spring/mass combination is tuned to reciprocate in a phase relationship with the moving parts of the machine to reduce significantly the reciprocation of the housing. The Ross et al. invention reduces the vibration transmitted from the housing of the machine to the surrounding structures.

Although vibration absorbers, such as described by Ross et al., help to reduce the vibration transmitted to the surrounding structures, there is a need to reduce vibrations in many machines.

### (f) BRIEF SUMMARY OF THE INVENTION

The invention is a vibration-reducing apparatus for a machine that vibrates at a fundamental frequency and at least one other harmonic frequency. Commonly, machines vibrate at a plurality of harmonic frequencies. The vibration-reducing apparatus comprises a first spring and mass combination drivingly linked to the machine. The first spring and mass combination forms a first vibration absorber with a natural frequency of oscillation substantially equal to the fundamental frequency at which the machine vibrates. The vibration-reducing apparatus includes a second spring and mass combination drivingly linked to the machine to form a second vibration absorber with a natural frequency of oscillation substantially equal to said at least one harmonic frequency.

In another embodiment, the machine vibrates at a plurality of harmonic frequencies, and the apparatus further comprises a third spring and mass combination drivingly linked to the machine. The third spring and mass combination forms a third vibration absorber with a natural frequency of oscillation substantially equal to a third harmonic frequency.

### (g) BRIEF DESCRIPTION OF THE SEVERAL VIEWS OF THE DRAWINGS

FIG. 1 is a side view illustrating an embodiment of the present invention.

FIG. 2 is a side view in section illustrating an alternative embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

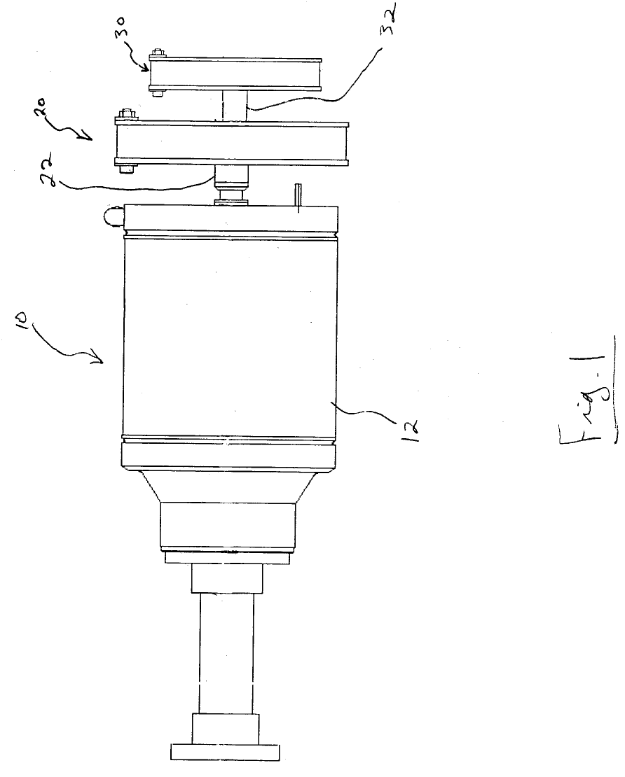

An embodiment of the invention is shown in FIG. 1. A machine, such as the free piston Stirling cycle machine 10, vibrates during normal operation. The free piston Stirling cycle engine, for example, has a very strong first harmonic, or fundamental, at the normal engine speed. Multiple higher harmonics also exist due to the inherent function of the engine. The machine 10 has a housing 12 that contains a piston and a displacer (not shown) reciprocatably mounted within a cylindrical cavity. Such free piston Stirling cycle machines are well known, and a representative example of such a machine is sold under the model number M87 Cryocooler by Sunpower, Inc. of Athens, Ohio.

As the piston and displacer oscillate at a frequency that is typically fixed at between 50 and 100 cycles per second, the housing 12 vibrates in a phase relationship to the combination of the piston and the displacer. Ordinarily, such machines operate at a fixed speed during operation. Because the fixed speed creates a characteristic frequency of vibration, the characteristic frequency of vibration at the fixed operating speed of the machine is referred to herein as the operating frequency. As the machine 10 operates at its operating frequency, it vibrates, and the vibration has a fundamental frequency and at least one harmonic frequency, such as the second harmonic frequency.

Drivingly linked to the machine 10, preferably by a substantially rigid connection to the housing 12, is a first spring and mass combination 20. The combination 20 is preferably a pair of planar springs sandwiching an annular mass between the springs near the outer peripheral edges of the springs. A rod 22 extends along the axis of the springs and mass and rigidly mounts to the housing 12.

The combination 20 is “tuned” to have a natural frequency of oscillation substantially equal to the fundamental frequency of vibration of the machine 10 at the operating frequency. Because the natural frequency of oscillation of a spring and mass combination is a function of the stiffness of the spring and the mass of the combination, the natural frequency of the combination can be varied by varying the stiffness of the springs or the mass of the entire combination or both. This is how the combination 20 is tuned so that its natural frequency substantially equals the fundamental frequency.

In addition to the spring and mass combination 20, a second spring and mass combination 30 is drivingly linked to the machine 10. Preferably, the rod 32 is rigidly mounted to the rod 22, which is rigidly mounted to the housing 12, or the rod 32 otherwise rigidly drivingly links to the machine 10. The rod 32 preferably mounts to the combination 30 along the axes of the springs and the mass. The combination 30 is preferably substantially similar in configuration to the combination 20, and has a pair of planar springs sandwiching an annular mass between the springs near the outer peripheral edges of the springs. The second combination 30 is tuned to a natural frequency of oscillation substantially equal to the second harmonic frequency of the machine 10.

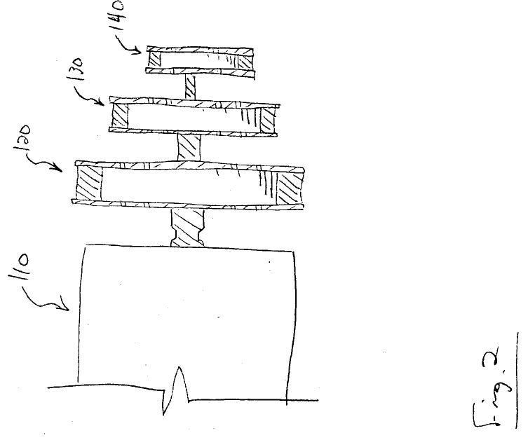

If there are more than two harmonic frequencies that are significant enough, additional spring and mass combinations can be added to the engine, as shown in FIG. 2, to serve as vibration absorbers. The machine 110 has a first spring and mass combination 120, a second spring and mass combination 130 and a third spring and mass combination 140, each of which has a pair of parallel planar springs sandwiching an annular mass therebetween. The first combination 120 absorbs the vibration of the fundamental frequency, the second combination 130 absorbs the vibration of the second harmonic frequency and the third combination 140 absorbs the vibration of the third harmonic frequency.

Thus, by tuning a plurality of spring and mass combinations, which function as vibration absorbers, to have natural frequencies of oscillation substantially similar to the fundamental and other harmonic frequencies, significant vibrations of the housing of the machine 10 can be absorbed. This results in a quieter and smoother machine.

It should be noted that the natural frequency of each of the spring and mass combinations described above is a function of the mass of the entire 10 combination, including the mass of the spring. It is possible that a machine may have an operating frequency with a harmonic substantially equal to the natural frequency of a spring without an attached massive object. Therefore, it is possible to avoid the necessity of attaching a separate object to the spring by using a more massive spring. However, because the mass of a spring normally also affects the spring's stiffness, adding mass to a spring to tune the spring and mass combination is a less advantageous method of altering the natural frequency of the combination. Nonetheless, it is to be understood that the spring and mass combinations described and claimed herein include both the combination of a spring and a separable object serving as a mass, and a spring without a separable object serving as the mass.

As an alternative to a pair of planar springs and a mass, the mass and spring combinations could have a coil, gas, magnetic, elastomeric or other springs mounted to a mass. Furthermore, although it is preferred to connect the mass and spring combinations to the machine 10 with the rod oriented along the axis of the springs and mass, it is possible to mount a connecting structure at the periphery of the springs and position the mass near the center of the springs. This alternative is a reversal from that shown in FIGS. 1 and 2 of the positions of the mass and the structure connecting the combination to the machine.

There is no limit to the number of spring and mass combinations that can be drivingly linked to a vibrating machine. However, it is estimated that in most circumstances only the fundamental frequency and the next few harmonics will be so noticeable that a spring and mass combination is needed to absorb the vibration.

There is also no limit to the type of machine that would benefit from the invention. Essentially any machine operating at a fixed frequency is contemplated as a candidate for the invention. Thus, Stirling cycle coolers, engines and compressors, internal combustion engines, and other machines that have measurable vibration are candidates for the benefits of the invention. Of course, if a variable natural frequency mass and spring combination is used, the machine could be operated at various frequencies.

While certain preferred embodiments of the present invention have been disclosed in detail, it is to be understood that various modifications may be adopted without departing from the spirit of the invention or scope of the following claims.

1. A vibration-reducing apparatus for a machine that vibrates at a plurality of harmonic frequencies, the apparatus comprising:
a) a first spring and mass combination drivingly linked to the machine to form a first vibration absorber with a natural frequency of oscillation substantially equal to one of said plurality of harmonic frequencies; and
b) a second spring and mass combination drivingly linked to the machine to form a second vibration absorber with a natural frequency of oscillation substantially equal to another of said plurality of harmonic frequencies.

2. The vibration-reducing apparatus in accordance with claim 1, wherein said plurality of harmonic frequencies comprises two harmonic frequencies.

3. The vibration-reducing apparatus in accordance with claim 2, wherein the first vibration absorber's natural frequency is substantially equal to a fundamental frequency.

4. The vibration-reducing apparatus in accordance with claim 1, wherein the plurality of harmonic frequencies comprises more than three harmonic frequencies and the apparatus comprises as many spring and mass combinations as harmonic frequencies.

5. The vibration-reducing apparatus in accordance with claim 1, wherein said plurality of harmonic frequencies comprises three harmonic frequencies, and the apparatus further comprises a third spring and mass combination drivingly linked to the machine to form a third vibration absorber with a natural frequency of oscillation substantially equal to a third of said three harmonic frequencies.

6. A vibration-reducing apparatus for a machine that vibrates at a fundamental frequency and at least one harmonic frequency, the apparatus comprising:
a) a first spring drivingly linked to the machine and a first mass mounted to the first spring, the first spring and first mass combining to form a first vibration absorber with a natural frequency of oscillation substantially equal to the fundamental frequency;
b) a second spring drivingly linked to the machine and a second mass mounted to the second spring, the second spring and second mass combining to form a second vibration absorber with a natural frequency of oscillation substantially equal to said at least one harmonic frequency.

7. The vibration-reducing apparatus in accordance with claim 6, wherein the machine also vibrates at another harmonic frequency, and the apparatus further comprises a third spring drivingly linked to the machine and a third mass mounted to the third spring, the third spring and third mass combining to form a third vibration absorber having a natural frequency of oscillation substantially equal to said other harmonic frequency.

8. The vibration-reducing apparatus in accordance with claim 7, wherein the springs are planar springs, and the masses are annular bodies, and each annular body is sandwiched between a pair of planar springs.

9. The vibration-reducing apparatus in accordance with claim 6, wherein said at least one harmonic frequency comprises a plurality of harmonic frequencies, and the apparatus further comprises a plurality of spring and mass combinations drivingly linked to the machine to form a plurality of vibration absorbers, each of said vibration absorbers having a natural frequency of oscillation substantially equal to a respective harmonic frequency.

10. A vibration-reducing apparatus for a free piston machine having a piston slidably mounted in a housing for oscillating, and the machine vibrates at a fundamental frequency and at least one harmonic frequency, the apparatus comprising:
a) a first spring drivingly linked to the machine and a first mass mounted to the first spring, the combination of the first spring and first mass forming a vibration absorber with a natural frequency of oscillation substantially equal to the fundamental frequency;
b) a second spring drivingly linked to the machine and a second mass mounted to the second spring, the combination of the second spring and second mass forming a vibration absorber with a natural frequency of oscillation substantially equal to said at least one harmonic frequency.

11. The vibration-reducing apparatus in accordance with claim 10, wherein the machine also vibrates at another harmonic frequency, and the apparatus further comprises a third spring drivingly linked to the machine and a third mass mounted to the third spring, the combination of the third spring and third mass forming a vibration absorber having a natural frequency of oscillation substantially equal to said other harmonic frequency.

12. The vibration-reducing apparatus in accordance with claim 11, wherein the springs are planar springs and each mass is sandwiched between a pair of planar springs.

13. The vibration-reducing apparatus in accordance with claim 10, wherein said at least one harmonic frequency comprises a plurality of harmonic frequencies, and the apparatus further comprises a plurality of spring and mass combinations drivingly linked to the machine to form a plurality of vibration absorbers, each of said vibration absorbers having a natural frequency of oscillation substantially equal to a respective harmonic frequency.
